(19) United States
(12) Patent Application Publication
(10) Pub. No.: US 2026/0307166 A1
(43) Pub. Date: Oct. 8, 2026

(54) SYSTEM AND PROCESS FOR WIRE-BASED OMNI-DIRECTIONAL PLASMA ARC DIRECTED ENERGY DEPOSITION OF METALS

(71) Applicant: AUGUSTINE TECHNOLOGIES LLC, Plymouth, MI (US)

(72) Inventor: Russell V. HUGHES, PLYMOUTH, MI (US)

(21) Appl. No.: 19/637,375

(22) Filed: Apr. 2, 2026

Related U.S. Application Data
(60) Provisional application No. 63/783,639, filed on Apr. 4, 2025.

(51) Int. Cl. B23K 10/02; B22F 10/22; B22F 10/85; B33Y 10/00; B33Y 30/00; B33Y 50/02

(52) U.S. Cl. CPC B23K 10/027; B22F 10/22; B22F 10/85; B33Y 10/00; B33Y 30/00; B33Y 50/02

(57) ABSTRACT

A method for forming a three dimensional (3D) metal part using a plasma arc system having a plasma arc welding torch and wire positioning mechanisms which are configured to separately guide metal wires in non-vertical directions, the method includes steps of: controlling the wire positioning mechanisms to guide the metal wires to positions within a plasma arc created by the plasma arc welding torch to form a common metal melt pool; and moving the plasma arc welding torch in X and Y directions within a plane while simultaneously, independently adjusting heights of the metal wires, as guided by the wire positioning mechanisms, relative to the metal melt pool so as to create a 3D metal bead having uniform height and width on a substrate.

### CROSS-REFERENCE TO RELATED APPLICATIONS

This application claims priority to US Provisional Application Ser. No. 63/783,639 filed Apr. 4, 2025. The entire subject matter of this priority application is incorporated by reference herein.

### BACKGROUND OF THE INVENTION

### Field of the Invention

The present invention relates to a simplified system and process for wire-based, omni-directional deposition of metals, including deposition involving formation of large and/or complex shapes and workpieces with the deposited metals, which system and method may involve wire-based, plasma arc directed energy deposition (DED) and other deposition technologies. More particularly, the present invention relates to such a simplified system and process in which the wire-based omni-directional deposition of metals can be precisely surprisingly achieved using only simple, two dimensional movements of a workpiece, even when the metal deposition involves formation of large and/or complex shapes and workpieces with the deposited metals.

### Description of the Background Art

There are known processes for deposition of metals, including wire-based omni-directional deposition of metals.

### MIG Process

One known process is Gas Metal Arc Welding (GMAW), or, as it better known, Metal Inert Gas (MIG) process. In a MIG welding process a welding torch is arranged to point vertically, or approximately vertically, downwards towards a substrate or workpiece. An electrode used in a MIG process is, in fact, a wire to be melted and deposited in the process. The wire is fed down a coaxial conduit within a body of the welding torch, passes through a contact tip of the torch and is melted by an electrical arc created between the emerging wire end and the workpiece. The process uses a constant voltage type power source for creating the arc, which keeps the length of the welding arc at a constant, self-regulating, length. In the MIG process, unlike some other known metal deposition processes including plasma arc welding, there is no “leading” or “trailing” edge to a pool of molten metal formed from the wire, because the wire is introduced and melted co-axially after being fed vertically down through the welding torch. As understood in the art, the vertical orientation of a MIG torch allows the torch to be moved in any direction, with the resultant weld bead being of uniform shape/profile. MIG techniques are now commonplace in three dimensional (3D) metal printing, especially so when affixed in robots. For the present disclosure such type of wire feed arrangement in which the metal wire is fed co-axially down through the welding torch or other high-intensity heat device will be referred to as “co-axial wire feed”.

The MIG process is somewhat similar to what happens in a plastic extruder used in 3D printing plastic polymer “wire”, or “line”, in which the polymer wire as typically supplied on spools, is drawn by a feeding mechanism into a melting device, where it is subsequently extruded downwards in a liquid or quasi-liquid state. Simple three-axis mechanisms, involving X, Y and Z axes, create controlled movement of a plastic extruder head such that a continuous bead of polymer material is printed, creating complex, yet fully functional parts. The very simplicity of the three-axis motion system is due to the ability to extrude the melted polymer line in any direction, which is something that cannot be done with the metal wire used in certain welding technologies.

### 3D Metal Printing

3D metal printing is another known process for wire-based omni-directional deposition of metals, and over the last couple decades has gained much attention for creation of high tech, complex shaped metal parts. The industries to which 3D metal printing is most attractive are unsurprisingly those where very expensive metals are commonly employed, generically these industries are classified as “Aerospace”. This pertains to the fact that 3D metal printing has the ability to produce parts that are very close in size and shape to a finish machined part, an ability which minimizes scrap in the form of swarf that is removed using machining operations after the parts are initially formed. This makes 3D metal printing very attractive because it greatly reduces the amount of expensive metals used in initially forming the parts, and also simplifies the machining operations needed to finish the parts.

Oftentimes, the aerospace metals are very difficult to shape by forging, challenging to cast and just as difficult to machine, all of which make 3D printing of them desirable. The MIG process is not approved, nor relied on to any notable degree, within aerospace companies because it is understood that the MIG process can make deposits prone to a wide variety of defects. For example, cracking in the start and stop zones of the deposited metal and lack-of-fusion between beads are commonplace. Defects such as these are not tolerable in the aerospace industries.

### Plasma Arc and Other 3D Metal Printing Techniques

Around the beginning of the 21st Century, plasma arc welding techniques, along with several other processes including laser and electron beam welding, emerged as methods that, having in most cases been applied to metal cladding or surfacing, could be extended to Wire Arc

Additive Manufacturing (WAAM), also known as 3D metal printing. According to a 3D metal printing technique. A single metal wire is non-coaxially delivered to the front of a melt pool of metal created by a plasma torch, while the hot metal deposit is protected from atmospheric contamination by a shielding device that delivers a shield of inert (argon) gas to the locale trailing the plasma torch whereby as the wire is added and melts at the front of the melt it then solidifies as a bead of deposited metal under the coverage of the shielding device. It is also conventional to use two metal wires in a WAAM process, wherein the two wires are separately, delivered adjacent to each other, e.g., at a leading edge or a trailing edge of a metal melt pool.

Other known alternative welding processes include Tungsten Inert Gas (TIG) as well as laser beam and electron beam welding processes. Until recently, all of these technologies were significantly limited based on delivery of the metal wires that are required to be melted and added to a melt pool, much, they suffered the same challenges of not only requiring multi-axis, e.g., six or more axes, motion systems, but also involved the same cumbersome and limiting wire delivery equipment.

For the laser and electron beam processes, wire handling issues have recently been solved to some extent. Similar to the wire handling in MIG welding, according to recent developments in the laser and electron beam processes, a single metal wire can be oriented vertically, feeding downwards into a melt pool. A Spanish company, Meltio™, has developed a system where multiple lasers are oriented around a vertically delivered wire (hereinafter “coaxial” wire delivery), the laser beams are focused so as to melt the single wire at the point of impingement on the substrate, and at the same time create sufficient melting of the substrate to fuse the melted wire to it. Unlike MIG welding, where the speed of delivery of the wire and the energy applied are intimately related, with the Meltio™ process, energy input and wire feed are independent variables and as such can be independently “tuned” to optimize the deposition of metal. Meltio™ has reported aerospace quality 3D printed parts are being made, albeit at modest rates of metal deposition, e.g., 4 kg/hr. Presumably deposition is limited by available laser power or wire feeding speed capabilities. Other companies engaged in the use of electron beams have developed a methodology similar to that used by Meltio™, but in which a “hollow, conical” electron beam is shaped to surround a single, vertically oriented metal wire, another coaxial wire delivery, melting it and a substrate in similar fashion to the laser based technologies. For the electron beam processes deposition rates of up to 8 kg/hr are claimed.

### Plasma Arc Welding Developments for 3D Metal Printing

Fundamental advantages of the plasma process over other arc welding techniques, like MIG, include the independence between arc power and wire feeding rates and the known ability to produce deposits of quality requisite to the aerospace industry keep it attractive as a method for metal 3D printing, or wire-based DED. However, a major underlying limitation of plasma arc welding is the difficulty of non-coaxially adding wire continuously at the front of a deposited bead when forming a 3D part, while preventing entanglement within the metal wire delivery mechanisms. Any motion that requires rotation or twisting of the welding torch itself, especially on a regularly occurring basis as will happen in printing a complex 3D part, will result in interference and other problems associated with the wires and the wire delivery mechanisms.

The present inventor has previously proposed a 3D metal printing machine involving plasma arc technology having an internal arrangement in which two wire feeding devices separately, non-coaxially direct each of the two metal wires downward into guides located in an adjusting mechanism that separately position the two wires for entry into the front of a melt pool relative to the movement direction of the plasma welding torch.

In order to create a 3D metal part according to the previous proposal a minimum of four (4) axes of motion are needed, i.e., transverse and longitudinal motions (X and Y axes) of the welding torch within a plane, upward motion (Z Axis) of the welding head as it builds successive layers one upon the other and finally and most significantly, a rotational axis which spins a turntable on which a part is being printed. The purpose of rotating the substrate and part being made is to ensure that the two fed wires are at all times directed into the leading edge of the melt pool. Directing wire into the trailing edge of the pool, or too far to one side of the pool, may lead to several problems, including excessive dilution, over-melting of a previous deposit and the possibility that either one or both of the wires may get “frozen” into the deposited bead as it solidifies behind the melt pool, typically due to “cast” in either of the wires. Cast is where the wires exhibit curvature as they emerge from the wire guiding devices, and can relocate the wires from the optimum entry points to the melt pool, and cause the wires to be entrapped in an area of solidification of the metal bead. Cast is a result of the metal being tightly wound on circular spools, the most prevalent method for supplying metal wires in the welding industry.

Adding a rotational fourth axis to a 3D metal printer, as discussed above, allowed a diverse range of “aerospace” parts to be made with using plasma arc technology. However, a major problem that still exists with metal 3D printing is that the more axes of motion added to a DED system the greater its complexity and the greater become the challenges of preventing entanglement, twisting and binding of the wire guiding mechanisms, etc., especially where two or more metal wires are involved. More complex parts often incorporate bosses or lugs on their periphery that even with additional motion axes, such as provided by a six axis robot working with a synchronous, additional, tilt/rotate unit for eight axes in total, cannot be readily built by a process with a non-coaxial wire delivery limitation, which is the current state of the art for the plasma 3D metal printing process. In short, for the plasma process to hold a place in 3D printing applications, it must match the abilities of the rival Laser and Electron beam techniques that use a coaxial wire delivery method and do not apply rotation to the weld head.

A variant of plasma welding known as plasma-MIG is known. This involves a hollow electrode within the plasma torch through which a wire is fed, while a constant voltage power supply is connected between the wire and the substrate on which the plasma arc column is also to connect, whereby two arcs existed within a common conductive column, i.e., a plasma arc and a MIG arc. However, plasma-MIG is known to create non-uniform bead deposits with variable dimensions, which are not tolerable in the aerospace industries.

Hence, there still remains a need in the art for improved technology which can allow use of plasma arc welding technologies for forming highly complex metal 3D printed parts using a relatively simple process, and for otherwise facilitating the ability to produce a 3D metal bead having uniform height and width on a substrate and thereby form high quality, high complexity metal 3D printed parts at higher deposition rates and reduced costs using any appropriate welding technology.

### SUMMARY OF THE INVENTION

It is an object of the invention to satisfy the discussed need.

After much experimental testing and investigation the present inventor has made some important discoveries that have lead to the present invention. The inventor's discoveries mostly focus on non-coaxial delivery of the metal wires into a melt pool and simplifying movements of the plasma arc welding apparatus required to create a complex 3D part so as to avoid significant problems of conventional plasma arc welding technology involving positioning and adjustments of the wires being fed into a melt pool formed by a plasma weld torch. For these experiments the feeding and positioning of the wires may be independently controlled.

According to a first aspect and embodiment of the present invention, there is provided a method for forming a three dimensional (3D) metal part using a plasma arc system having a plasma arc welding torch and wire positioning mechanisms which are configured to separately guide metal wires non-coaxially with the plasma arc welding torch, the method comprising steps of: controlling the wire positioning mechanisms to guide the metal wires to positions within a plasma arc created by the plasma arc welding torch to form a common metal melt pool; moving the plasma arc welding torch in X and Y directions within a plane while simultaneously, independently adjusting heights of the metal wires, as guided by the wire positioning mechanisms, relative to the metal melt pool so as to create a 3D metal bead having uniform height and width on a substrate.

The method according to the first aspect, wherein the plasma arc system further includes height adjustment mechanisms for independently adjusting heights of the wire positioning mechanisms to adjust the heights of the metal wires, the height adjustment mechanisms including motors.

The method according to the first aspect, wherein the plasma arc system includes two of the wire positioning mechanisms which respectively guide two of the metal wires non-coaxially into the plasma arc at opposite side positions relative to a direction of motion of the plasma arc welding torch, and the metal wires as guided into the plasma arc at the opposite side positions are positioned at different entry point heights into the plasma arc based on locations of opposite side positions relative to the direction of motion of the plasma arc welding torch. Further, when the wire positioning mechanisms guide the metal wires into the plasma arc at locations on opposite front and rear side positions relative to the direction of motion of the plasma arc welding torch, the metal wire guided into the plasma arc at the rear side position is positioned at an entry point height above an entry point height of the metal wire guided into the plasma arc at the front side position. Also, a difference in the entry point heights of the metal wires into the plasma arc becomes greater as the location of a front one of the locations on the front side position is closer to the travel direction of motion of the plasma arc welding torch, whereas when the wire positioning mechanisms guide the metal wires into the plasma arc at locations on opposite lateral side positions displaced 90° relative to the direction of motion of the plasma arc welding torch, the metal wires are positioned at the same entry point height into the plasma arc.

The method according to the first aspect, wherein the plasma arc system includes two of the wire positioning mechanisms, and wherein the method involves five axes of movement of the plasma arc system, including the X and Y directional planar movements of the plasma arc welding torch, Z axis movements of the plasma arc welding torch for increasing the height of the welding torch, and independent adjustments of the heights of the two wire positioning devices.

The substrate may be supported on a surface, and the surface may be movable in at least one of a rotating motion and a tilting motion while the 3D metal part is being formed.

The method and system according to the present invention advantageously permits complex 3D metal parts, including very large such parts, to be created (printed) using a relatively simple process involving non-coaxial delivery of metal wires, and for otherwise facilitating the ability to produce a 3D metal bead having uniform height and width on a substrate and thereby form high quality, high complexity metal 3D printed parts at higher deposition rates and reduced costs using any appropriate welding technology

### Intent of Disclosure

Although the following disclosure offered for public dissemination is detailed to ensure adequacy and aid in understanding of the invention, this is not intended to prejudice that purpose of a patent which is to cover each new inventive concept therein no matter how it may later be disguised by variations in form or additions of further improvements. The claims at the end hereof are the chief aid toward this purpose, as it is these that meet the requirement of pointing out the improvements, combinations and methods in which the inventive concepts are found. There has been chosen a specific exemplary embodiment of a plasma arc deposition system according to the invention and specific alternative structures and modifications thereto, the embodiment having been chosen for the purposes of illustration and description of the structure and method of the invention are shown in the accompanying drawings forming a part of the specification.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a rear perspective view of an embodiment of a plasma-arc deposition system according to an embodiment of the present invention independently feeding two metal wires to lateral sides, respectively, of a melt pool.

FIG. 2 is a side perspective view of the embodiment of a plasma-arc deposition system of FIG. 1, but rearranged so that it is independently feeding two metal wires to leading and trailing edges, respectively, of a melt pool.

FIG. 3 is a front perspective view of an embodiment of a plasma-arc deposition system according to the present invention for independently feeding two metal wires to opposite lateral sides, or to leading and trailing edges, of a melt pool while also independently adjusting a height of each of the wires above a substrate surface.

FIG. 4 is an enlarged view of a key portion of FIG. 3 better showing the different heights of the wires above the substrate surface as the wires are fed non-coaxially.

FIG. 5 is a plan view illustrating a circular print path in which an embodiment of a 3D metal printing system according to the present invention may be programmed to move according to an exemplary embodiment of a 3D printing process according to the present invention while printing a 3D metal part, and showing twelve equally spaced intervals around the circular path at which heights of the two wires being fed into a melt pool may be independently adjusted to assure uniform width and height of the metal bead being formed by the system.

FIGS. 6A and 6B are respectively a perspective view and a front view of the system according to the embodiment of the present invention as the system prints a first layer of a circular 3D metal part at position A in FIG. 5.

FIGS. 7A and 7B are similar to FIGS. 6A and 6B, but depict the circular 3D metal part at position B in FIG. 5; FIGS. 8A and 8B are similar to FIGS. 6A and 6B, but depict the circular 3D metal part at position D in FIG. 5; FIGS. 9A and 9B are similar to FIGS. 6A and 6B, but depict the circular 3D metal part at position F in FIG. 5; FIGS. 10A and 10B are similar to FIGS. 6A and 6B, but depict the circular 3D metal part at position G in FIG. 5; and FIGS. 11A and 11B are similar to FIGS. 6A and 6B, but depict the circular 3D metal part at position H in FIG. 5.

FIGS. 12A and 12B are similar to FIGS. 6A and 6B, but depict the perspective and front views as the system prints a second layer of the circular 3D metal part at position A in FIG. 5.

FIG. 13 is a top side perspective view of a modification of the system of FIG. 3 having four independently controlled metal wire guiding mechanisms which non-coaxially guide four metal wires into a plasma arc at four positions equally spaced 90° apart.

FIG. 14 is a top front perspective view of a modification of the system of FIG. 3 having four independently controlled metal wire guiding mechanisms which guide four metal wires into a plasma arc at two positions equally spaced 180° apart.

FIG. 15 is a schematic view of an embodiment of an AI controlled system for forming a three dimensional (3D) metal part using plasma arc technology according to the present invention.

FIG. 16 there is shown a schematic layout of an exemplary embodiment of a plasma arc 3D printing system which includes an AI control system together with plasma arc technology according to an exemplary embodiment of the present invention.

FIG. 17 is shown perspective view of infrared camera monitoring used in the embodiment of FIG. 16 while generating a circular 3D metal deposit.

### DETAILED DESCRIPTION OF PRESENTLY CONTEMPLATED EMBODIMENT

### Development of an Omni-directional Plasma DED Process

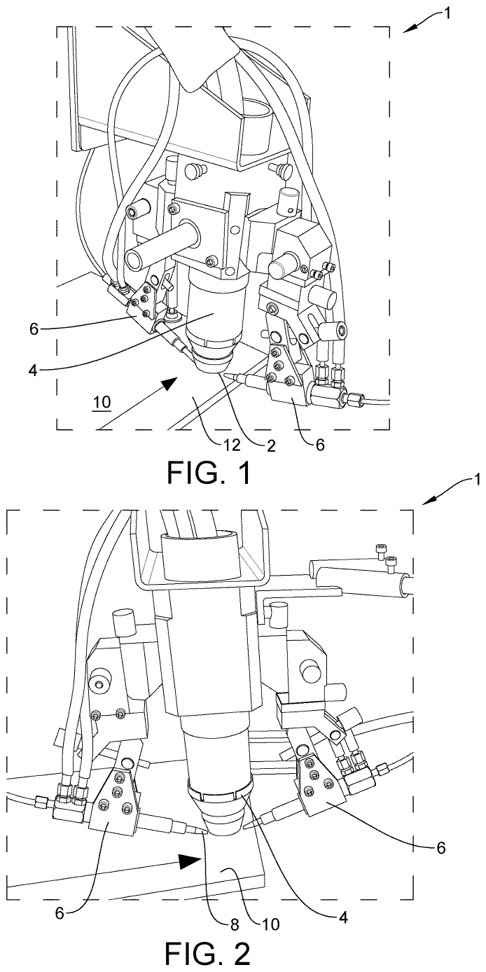

With reference to FIGS. 1 and 2, there is shown an exemplary embodiment of a wire-based, plasma arc directed energy deposition (DED) deposition system 1, aka plasma-arc 3D metal printing system, according to the present invention. For example, the system 1 may be a Gas Tungsten Arc (GTA) system. This system 1 shows the ability of the plasma arc technology to deposit quality metal beads with consistent height and width using two metal wires that are independently, non-coaxially fed to lateral sides, respectively, of a melt pool, see FIG. 1, or that are independently fed to leading and trailing edges, respectively, of a melt pool, see FIG. 2, rather than both wires being non-coaxially fed to the front leading edge of a melt pool as has been conventionally done, e.g., as in the inventor's previously proposed 3D plasma printing machine.

FIG. 1 is a rear perspective view of an the system 1 in which two identical metal wires 8, 8 are independently, non-coaxially fed and guided to lateral sides, respectively, of a melt pool 2 beneath the plasma torch 4, while FIG. 2 is a front view of the system 1 which has been reconfigured so that it is independently, non-coaxially feeds the two metal wires 8, 8 to leading and trailing edges, respectively, of the melt pool 2. Wire guiding devices 6, 6 independently guide each of the two metal wires to appropriate positions beneath a plasma arc generated by the plasma torch 4 so that the metal wires are melted and added to the melt pool 2.

A first discovery made by the inventor involved the system 1 and relates to the positions of the metal melt pool 2 into which the metal wires 8, 8 are fed. Changes to the conventional method of adding two wires to the leading edge of the melt pool in a plasma arc welding process were investigated, and specifically it was discovered that uniform metal deposits having consistent width and height could be made by introducing the two wires into opposite lateral sides of the melt pool 2 relative to the travel direction of the welding torch (FIG. 1) or by introducing the two wires, one at the front and one at the rear of a melt pool relative to the travel direction of the welding torch (FIG. 2). For these tests, two different size wires, both 0.045 inch diameter (1.2 mm) or both 0.062 inch diameter (1.6 mm), and of a variety of metals, including mild steel, stainless steel, titanium and aluminum, were experimented with. The position of two added wires was experimented by using two configurations, one configuration where the two wires 8, 8 are added to the lateral sides of the melt pool relative to the travel direction of the welding torch, see FIG. 1, and the other where the two wires are respectively added at the front and rear of the melt pool relative to the travel direction, see FIG. 2, and for each configuration different heights of the two wires above a metal substrate 10 was also investigated. It was found that if the wire 8 on one lateral side of the melt pool was introduced either higher or lower than the opposite wire 8, the profile of the solidified metal deposit would change. Though generally of uniform cross-section, the width and height of the solid metal deposit would noticeably vary with differing wire heights, or points of entry into the arc column or melt pool, above the substrate.

With front and rear delivery of the two wires 8, 8, as in FIG. 2, it was discovered that the rear wire needed to be elevated to an entry point above that of the front wire to avoid entrapment of the wire in a deposit of the melt pool which rapidly solidified. Though a single or common melt pool was created and maintained for the two wires, a phenomenon was surprisingly discovered involving a “layering type” of metal deposition. Particularly, the front wire 8 when melted created a broad, yet modestly high, e.g., about 1 mm, front to the melt pool, while the rear wire 8, especially when introduced at a higher elevation, added to the deposit being made by the front wire, increasing the overall height of the melt pool and subsequently solidified deposit, but did not lead to any notable increase in the width of the deposit when compared to the width of deposits made with only the front wire added. When the two wires were of the same diameter and fed at the same speed, the above-described deposit saw an increase in height to 2 mm, or double that created by the introduction of only the front wire 8. Many tests were performed where only the front wire 8 was deposited, so that the dimensions (width and height) of the metal deposit 12 could be measured and compared to beads 12 made when the second wire was added. Provided the variable settings of the plasma torch 4 were kept constant, along with the power of the arc, which is a function of arc current and voltage, it was found across a range of metals, including mild steel, stainless steel, titanium and aluminum, that the addition of the second wire 8 at the rear of the melt pool 2 did not lead to any notable increase in the width of the deposit when compared to the width of deposits made with only the front 8 wire added. This was surprising as it seems logical to believe that arc energy devoted to melting the rear wire would reduce the amount of energy available for growing the width of the melt pool 2. It appeared that the size of the melt pool 2 in terms of its width was influenced to a dominant degree by the arc settings themselves and not necessarily by moderate changes in the “melting power” available.

Having discovered that uniform metal deposits with consistent width and height could be made using the system 1 by introducing two wires 8, 8 into the sides of a melt pool or by introducing two wires, one at the front and one at the rear of a melt pool, the inventor investigated differences in the dimensions of each type of deposit when wires of identical compositions and diameters were introduced at identical speeds into a plasma arc column of fixed power and height above a substrate, noting that dimensional consistency is critical for aerospace industries. At the same time, all critical settings within the plasma torch 4 were fixed. To create a deposit using wires 8, 8 at the opposite lateral sides of the melt pool 2 that exactly matched the dimensions of one made with front and rear added wires, it was discovered that the height of the two wires as they were introduced into the arc column and melt pool 2, above the substrate 10, needed to be the same, but different from the height of the front wire 8 in front/rear deposition configuration of the system 1. With the front/rear deposition configuration of the system 1, it was determined necessary for the rear wire 8 to be introduced at a higher point than the front wire 8, to avoid the common risk of that wire becoming entrapped in the solidifying melt of the deposit 12.

### Proving the Ability to Create Omni-directional Printing

The inventor then investigated ways to simplify the equipment and methods used to 3D print a complex, metal 3D part with plasma arc technology. To great surprise he discovered that an omni-directional, plasma arc metal printing process involving non-coaxial wire feed could be achieved using a highly simplified process involving only 3D movements of a plasma torch, i.e., planar movements of the torch in X and Y directions, Z axis movements of the plasma torch for increasing the height of the part being printed, typically in layers, and most uniquely, along with two additional axes for independent movements of the wire positioning devices primarily involving controlling heights of the metal wires as fed into the melt pool, for a total of five axes of movement, to form a 3D metal part on a substrate. For adjusting and controlling heights of the metal wires as fed into the melt pool, appropriate height adjusting mechanisms can be provided, e.g., including servo motors, stepper motors, or other appropriate actuators to cause linear motion of the wire positioning mechanisms. Most surprisingly, such process avoided the conventional need of supporting the substrate on a turntable and significantly moving the turntable during the forming process, that led to system parts becoming entangled.

After discovering that quality metal beads could be formed using the wire-based, plasma arc directed energy deposition (DED) deposition system or plasma-arc 3D metal printing system 1 in which the two wires 8, 8 are independently fed to the lateral sides of the melt pool 2 or to the front and rear edges of the melt pool 2, the inventor then conceived of such a system which could independently control the positioning of the two wires such that their heights were varied, continuously or periodically, during a 3D printing process. It was decided to use a circular path for a deposit, noting that if such a 3D metal part could be created with near perfect uniformity in height and width, that was made only by motion of the plasma arc welding apparatus in x and y directions, as opposed to rotation of a turntable, it would demonstrate that an omni-directional process was achievable. Following a circular print path using only changes in the X and Y co-ordinates of a motion system encompasses all variants of wire addition directions.

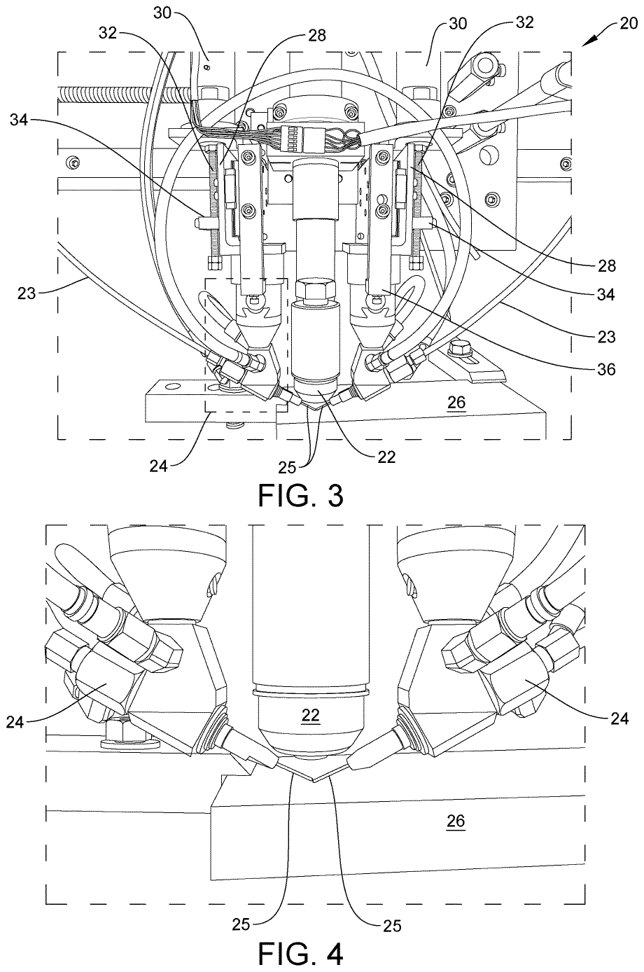

Referring to FIGS. 3 and 4 there is shown another embodiment of another wire-based, plasma arc directed energy deposition (DED) deposition system or plasma-arc 3D metal printing system 20 according to the present invention. FIG. 3 is a front view of the system 20, while FIG. 4 is an enlarged view of a key portion of the system which more clearly shows that the wire 25 on the right is disposed closer to a substrate 26 than the wire 25 on the left by a small amount, e.g., about 1 mm.

As shown in FIG. 3, the system 20 generally includes including a plasma torch weld head 22, wire positioning assemblies 24 which position metal wires 25, 25 that are fed down through conduits 23 from opposite sides into a melt pool (not shown) on a substrate 26 beneath the torch weld head 22, slide carriages 28 which independently move the wire guide assemblies up and down, servo motors 30 which move the slide carriages 28 under the control of one or more controllers (not shown), which processors may include memories and Computer Numerical Control (CNC) and/or artificial intelligence (AI) software control programs.

Though, as has been the case in the past, the two wires 25 are disposed to feed into a region (the melt zone) beneath the plasma torch head 22, each of the two wire positioning assemblies 24 are independently affixed to the respective servo motor operated slide carriages 28. As either of the servo motors 30 may be rotated by the controller(s) designed for this purpose, a leadscrew 32 permanently affixed to the motor rotates. A nut 34, engaging with the leadscrew, that may be fixed to a slide carriage 28 to which the wire positioning assembly 24 is mounted, is, as a consequence of the leadscrew rotation, moved upwards or downwards, as is the entire slide carriage 28. Such slide mechanism motion imparts identical upward/downward motion of the wire positioning assemblies 24. In operation, the two servo driven slide carriages 28 are able to effect positioning of each wire independently of one another at any chosen point within the arc column generated by the plasma torch head 22, or as is more easily described for the purposes of understanding this method of printing metal, at different heights above a substrate 26.

For this embodiment of the system 20 in FIGS. 3-4, the servo-driven slide carriages 28 were selected because the other 4 axes of the 3D printing machine were also servo motor driven and it was thus easiest to create a “marriage” between the wire positioning assemblies 24 that perform wire lifting and a system controlling motions of the plasma torch head 22 in X, Y and Z directions, which could be incorporated into a robot. As will be understood, alternative mechanisms for moving the wires 25 could be used, such as stepper motor drives, linear motion drives or virtually any mechanism that creates movement of each of the wire positioning assemblies 24 and can be harmonized with the system that moves the plasma torch head 22. It can be seen and appreciated in FIG. 4 that the wire 25 on the right of the picture is a little closer to the substrate surface than the wire on the left. In practice this can be about 0.5 mm to 2.0 mm. It will also be understood that if the weld head assembly was operated and moved towards the right of the picture, it would be operating in the method previously described as front/rear deposition. The wire 25 on the right would melt and make up half of a deposit, while the wire 25 on the left, disposed above that deposit, would add to the height of the deposit, e.g., increasing it by 50%, assuming equal wire diameters and speeds. Positioning the wire 25 on the left at a level higher off the substrate 26 than the wire 25 on the right mitigates the risk, as described earlier, of the wire 25 on the left becoming entrapped in the deposit. To make a deposit that progresses from the right of FIG. 10, toward the left, it would be necessary to reverse the heights of wires 25, 25 above the substrate 26, i.e., the wire 25 on the left would be closer to the substrate and the wire 25 on the right would be at a higher elevation. On the other hand, if it was desired to print at ninety degrees to a leftward or rightward deposit (as described above), meaning the weld head would move “inwards” or “outwards” of the picture and thus a sideways type deposit would be in progress, each of the two wires would be positioned differently than before.

The metal 3D printing system and process as discussed in relation to FIGS. 3-4 including the wire positioning mechanisms 24, the slide carriages 28, etc., were incorporated into a motion control system such as used for a conventional plasma arc 3D printing system. As discussed herein, the motion control of such a system may be a four axes system, involving three axes (X, Y, Z) movements of a plasma torch head together with a fourth axis in the form of a rotatable turntable for moving metal the part being printed. CNC is typically used for controlling the motions of such four axis systems, and CNC can also be used control height adjustment of the two independent wire positioning systems to be optimal for the deposition of beads having uniform height and width depending on which direction the plasma torch head of the system is moving. Essentially, this results in a six axes, omni-directional, plasma arc, printing system and method.

However, such a six axes system remained unduly complex as the rotation of a turntable supporting the part being printed was still likely to lead to problems involving entanglement of system parts, especially wire feeding mechanisms and wire positioning mechanisms 24. Hence the inventor further investigated this and, to his great surprise, discovered that it was practically possible to eliminate the rotating turntable if the independent wire positioning mechanisms 24, the slide carriages 28, etc. which are controlled to carefully adjust, periodically or continuously, the heights of the wire positioning mechanisms 24 throughout a plasma arc, 3D printing process, including the three axes (X, Y, Z) of movement of the plasma torch head and the independent height adjustments of the two wire positioning mechanisms 24 using the slide carriages 28.

It was surprisingly determined that the three axis motion control system for the plasma torch head 22 could be properly effected using CNC programming which also automatically set and adjusted the positions of the two wire positioning mechanisms 24 to be optimal to allow the deposition of entirely uniform beads, e.g., uniform width and height, depending on which direction the system is moving the plasma torch head 22. For this a circular path for printing a 3D metal part was used. In practice, the printing of a circular deposit using only XY motion presents essentially all combinations of wire positioning that the Front/Rear or Sideways additions scenarios described herein, for best demonstrating that a metal bead having uniform width and height can be created with the plasma arc 3D printing system according to the present invention, which makes it possible to create high quality metal parts suitable for the aerospace industry.

Surprisingly, this eliminated the conventional need for rotating a turntable which supported the substrate on which the metal part is formed, which is significant not only because of the size and complexity of a turntable that might be required for supporting and rotating a large, complex part weighing several tons and with unusual shapes, but also because the part could be formed using only relatively uncomplicated movements of the metal wire feeding devices that do not lead to tangling of the wire feeding devices and other problems, such as those which are experienced with the conventional plasma arc 3D metal printing technologies. Prior to the present invention, complicated movements of the wire feeding devices have been a major stumbling block preventing the use of plasma arc technology for printing complex 3D metal parts, e.g., in the plasma arc devices the metal wire must be non-coaxially fed into the plasma torch, whereas the wire feeding devices had to be often rotated around the plasma torch head and then rewound when printing a 3D part, which leads to entanglement.

### Homing of the Wire Height Adjustment Devices (Slide Mechanisms)

Prior to commencing a print according to the exemplary embodiment of the present invention, both slide carriages 28 may be moved by the control system to either the top or the bottom of their travel, or any other datum position, whereupon each carriage 28 engages against a stopping pin or similar element such as homing position device 36 shown in FIG. 3. Upon such engagement the servo motors 30 driving motion of the slide carriages 28 become stalled. It is characteristic of such motors and their controls that under such loading the motor armature will draw more current in an attempt to keep the motor turning. This sudden increase, called the “stalling” current can be detected by the controller, and thereby register the position of the slide carriage 28 as being at “Home”. Alternatively a micro-switch, Reed Switch or other appropriate sensor can be utilized to create a similar indication of the Home position. The Home positions are engineered to be a precisely known distance from the front face of a constricting nozzle of the plasma torch head 22. In practice, the distance between the front face of the plasma torch head 22 and the substrate 26 may be set to a pre-selected distance, known as the arc gap or stand-off distance, e.g., between 5 mm and 25 mm. As an example, a stand-off distance of 10 mm is selected for the purpose of making a deposited bead. From the Home position of the wire, chosen to be at the front of the melt pool the slide carriage 28 would reposition the height of the associated wire positioning mechanism 24 so that the underside of said wire 25 would just touch (or be proximate) the surface of the substrate 26. Thus, this front wire would be termed to be at the zero lift position. The slide carriage 28 for the rear wire 25 would locate this wire such that its underside is elevated above the substrate at a height of, by example 3 mm, this being chosen to ensure that in operation the rear wire 25 will not become entrapped in the solidifying melt pool. Since the weld head manipulation system (CNC machine or robot) may be programmed in advance of making a printed part, it will know in advance the start point of the forthcoming deposit and the direction of travel along with a pre-determined stand-off distance of the plasma torch head 22 above the substrate 26, and the two slide carriages 28 can be pre-positioned so that the wire positioning mechanisms will correctly set starting positions of the two wires 25 to proper heights before the deposition process commences.

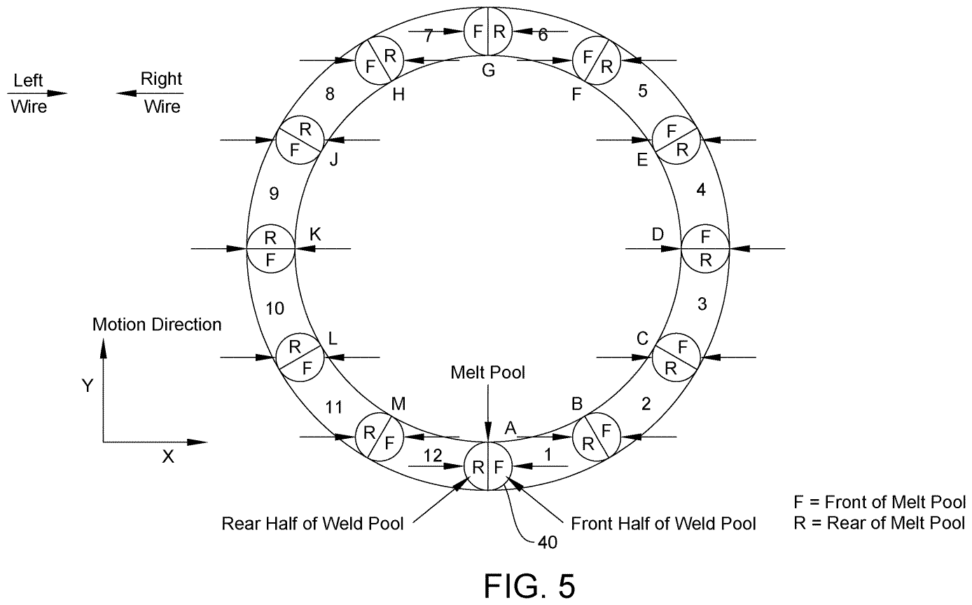

Referring to FIG. 5, the following is a simplified description of an investigation proving the effectiveness of adjustment of the heights of the positioning mechanisms for the two wires being fed into the melt pool while the plasma torch head is moved in a circular pattern using only X and Y axes planar movements when forming a circular shaped 3D deposit using the five axis system according to the exemplary embodiment of the present invention discussed above.

Starting at position A and considering 90° increments around a circular path, with the plasma torch head 20 moving counterclockwise, the front wire (right wire) in relation to the melt pool 40 is lower and the rear wire (left wire) is higher as was described earlier as front/rear welding; at position D, after 90° of motion on the circle, the front wire and the rear wire have now changed status to being sideways added wires, where their heights above the substrate should be the same, but both wires are higher than the front wire at position A, and lower than the rear wire at position A which is necessary to produce a deposit of constant cross-section in height and width; at position G, 180° from position A, the process returns to being a front/rear welding one, but the front wire in relation to the melt pool is now the left wire and is lower, while the rear wire is now the right wire and is higher; at position K, 270° from position A, the process returns to being one with sideways added wires with both wires at the same heights and exactly the same distance from the substrate as they were at position D; and finally returning to position A, at which point the plasma torch head is moved upward (Z axis) for the start of forming a next layer of the part being formed.

Similarly, starting at position A and considering 30° increments around the circular path, at position B the right wire is slightly less towards the front of the melt pool than it was at position A and the left wire is slightly less towards the rear of the melt pool than it was at position A; at position C the right wire is nearly at the side of the melt pool and the left wire too, is nearly at the side of the melt pool; at positions E and F, conditions are similar to those at positions B and C but the left and right wires have reversed positions, with the left wire gradually approaching the front of the melt pool and the right wire becoming more rearward; at positions H and J, the left wire is progressively moving away from the front of the melt pool, towards the side and the right wire is progressively moving from the rear of the melt pool towards the side; at positions L and M the left wire moves progressively towards the rear of the melt pool, while the right wire moves progressively towards the front of the melt pool; etc.

It was discovered that adjustments to the heights of the positioning mechanisms for the two wires above the substrate, if made at 30-degree increments of motion when printing a circular shaped 3D part, created a finished deposit of near-perfect uniformity in terms of width and height, thereby proving that the five axes system and method for plasma arc printing of a large, complex part can be done on a practical basis.

Of course, the heights of the metal wires being fed into the melt pool may be adjusted at more or less than twelve points of the circular path depending on the size of the circular part being printed. Also, essentially continuous adjustment of the heights of the two wires above the substrate is possible with CNC control, and AI coupled with the CNC control makes this possible in a practical manner. Depending on the type of metal being printed and the surface tension characteristics exhibited in the molten and semi-molten state, further refinements to the shape of the deposited bead can be made by making small changes to the Plasma Arc welding current and plasma gas flow rate during the deposition process, again possibly with AI assistance.

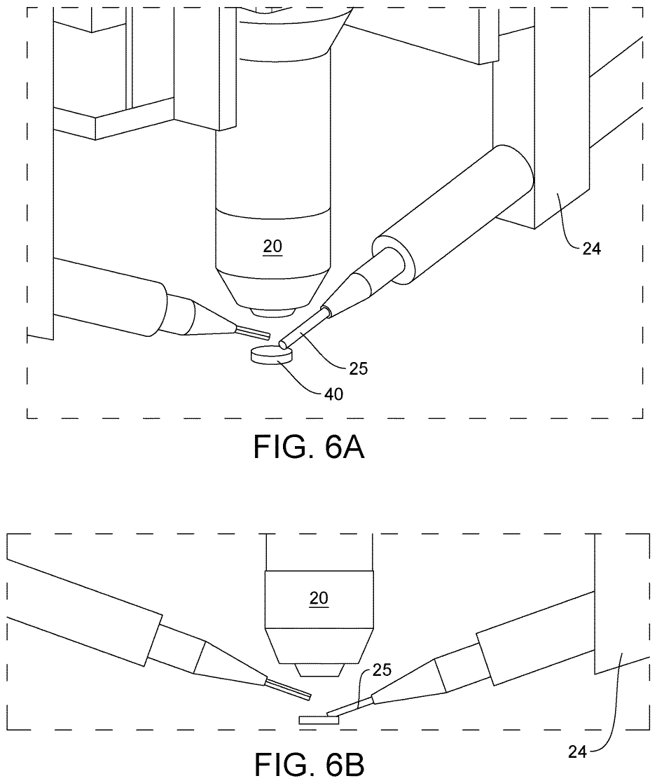

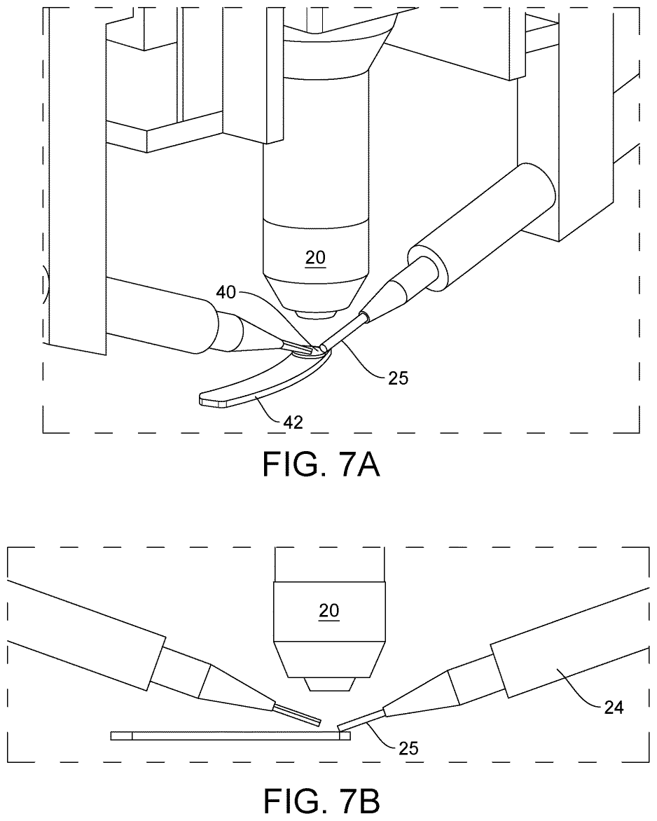

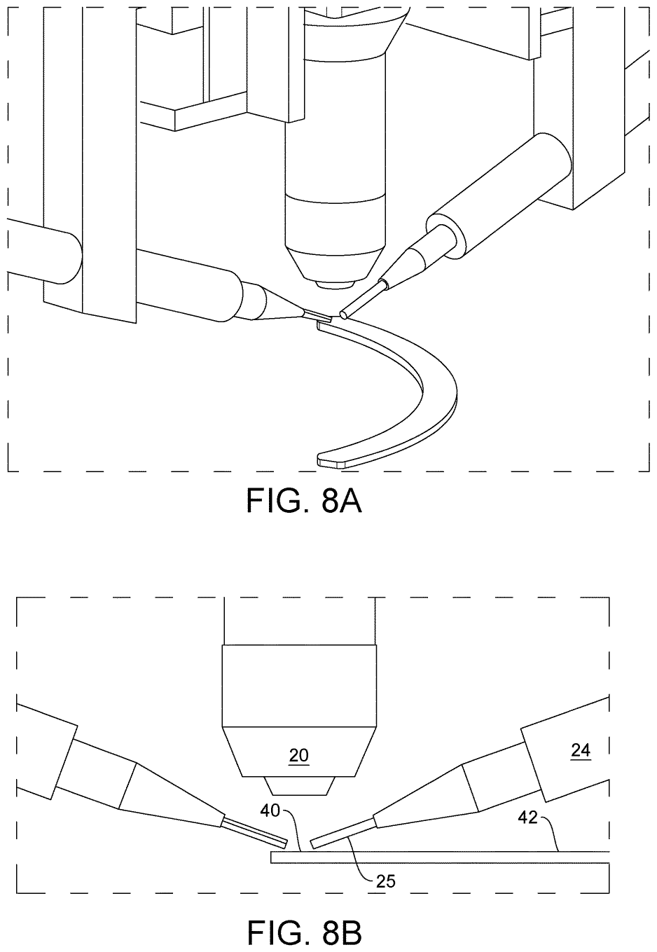

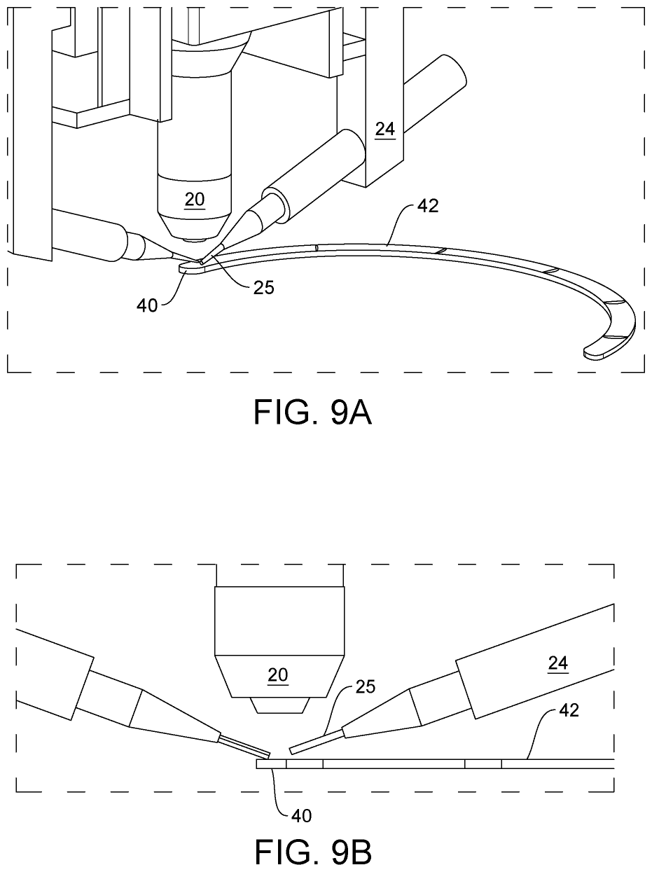

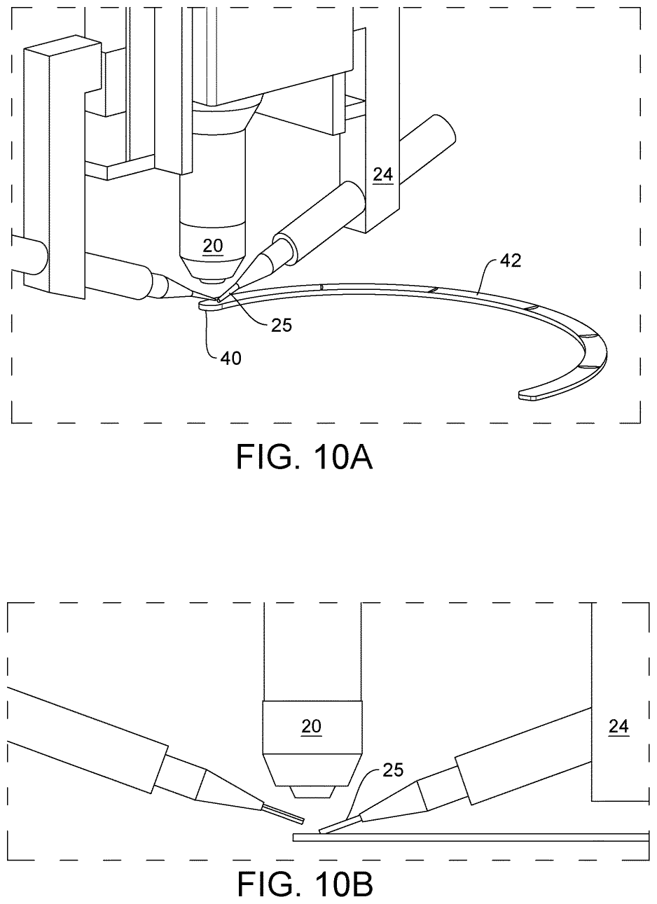

Referring to FIGS. 6A through 12B illustrate in greater detail the height adjustments of the wire positioning devices 24 according to the exemplary embodiment of the present invention using a five axes system and method discussed above while printing the circular shaped 3D part in FIG. 5. FIGS. 6A and 6B respectively show a perspective view and a front view of the five axis system as the system prints a portion of a first layer of a circular 3D metal part at the position A in FIG. 5, while similarly each pair of FIGS. 7A-7B, 8A-8B, . . . show perspective and front views of the system and the part being formed at positions B, D, F, G and H of the twelve equally spaced 30° increments around the circular path, and the different heights of the two wires being fed into a melt pool by the associated wire positioning mechanisms 24, under CNC control of the slide carriages 28, servo motors 30, etc., as adjusted in the corresponding position. Titanium metal wires of 1.2 mm diameter were used and these Figures also show the respective heights of the two wires 25 above the surface of the melt pool 40 or substrate at each corresponding incremented position of the circular deposit 42 being printed.

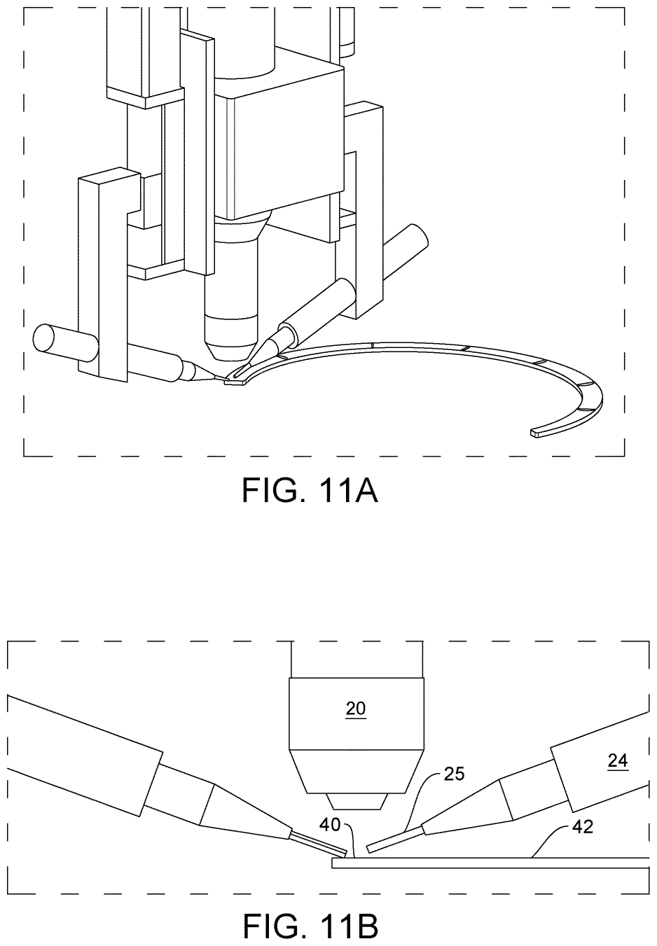

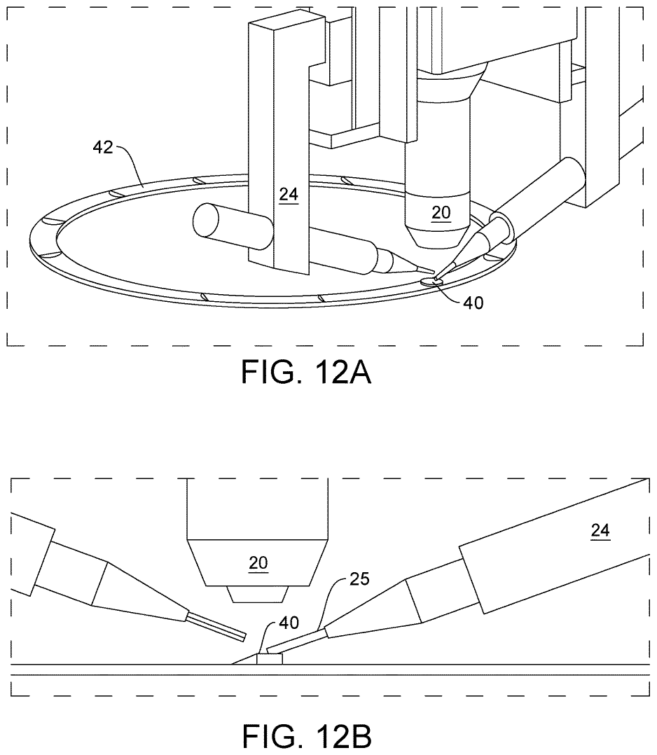

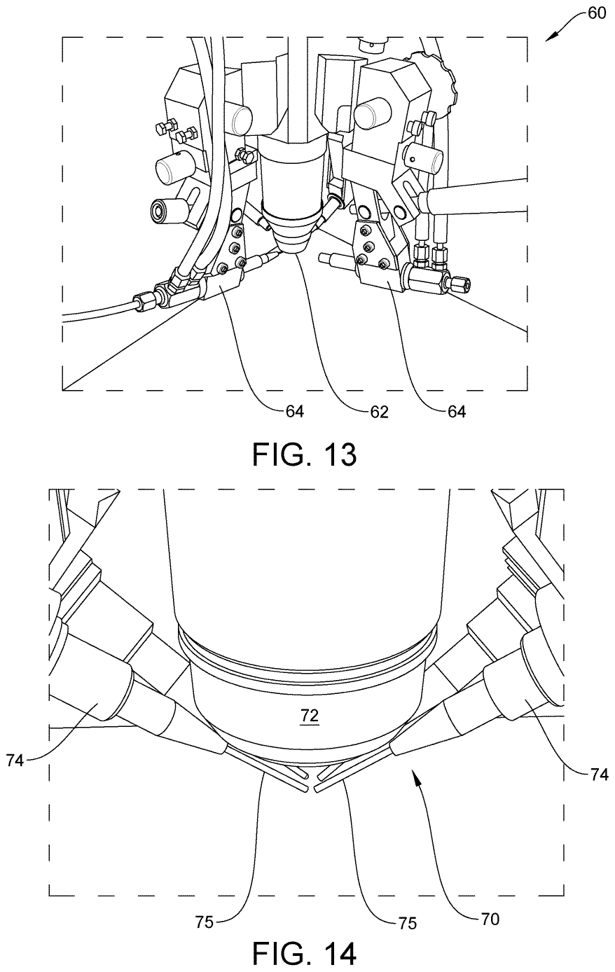

FIGS. 12A-12B are similar to FIGS. 6A-6B but shows a first portion of a second layer of the metal part being formed at position A in FIG. 5 after the plasma torch is adjusted upward (Z direction). After being adjusted upward, the system is then controlled in corresponding manner, including achieving the same height positions of the metal wires 25, 25 in depositing further amounts of metal at the twelve positions A-M in fully creating the second layer of the metal deposit 42. The same control of the system would be effected when generating further layers of the metal part, in which the plasma torch is adjusted upward (Z direction) at the beginning of the printing of each succeeding layer of the deposit 42.

With this plasma arc printing process according to the exemplary embodiment of the present invention using a five axis system and method discussed above, in which the heights of the two wire positioning mechanisms 24 were adjusted at 30° increments as the plasma torch head 20 was moved in only two directions (X and Y directions) in a plane for each layer of the deposit 42 and adjusted upward (Z direction) at the beginning of the printing of each succeeding layer of the deposit 42, is completed, this results in a circular 3D deposit 42 of an appropriate number of layers to achieve desired height of the metal part.

According to an exemplary circularly shaped deposit that was made by the system and process according to the exemplary embodiment using 1.2 mm titanium wires, width and height measurements were taken at the aforesaid 30 degree increments of FIG. 5, and it was determined that variations of the titanium deposit 42 were 0.15 mm on width and only 0.05 mm on height, except in the 0 degree/360 degree overlap position, where parameters were not optimized. In metal printing using Wire Arc Additive techniques, these are regarded as exceptionally small variations, and acceptable in the aerospace industries. The deposit 42 was created to include five (5) successive layers of printing by the system, each layer height being 2.4 mm and width of the deposit 42 as printed was 14 mm.

While the deposit 42 in the example still needed to be machined in order to form it into a “finished part” with smooth outer surfaces, it was found that less than one (1.0) mm of metal was removed from each vertical face of the deposit 42 to achieve complete clean-up or full machining of the deposit 42. This represents less than fifteen (15) % of the total amount of the metal wires deposited in forming the part 42. Phrased in aerospace terminology, this corresponds to a Buy-To-Fly (BTF) Ratio of 1.15 to 1 (1.15:1), which is very surprising and exceptional in comparison to titanium parts formed using conventional techniques. As a comparative example, consider an article Making 3D-Printed Parts for Boeing 787s, AEROSPACE AMERICA, September 2018. In this article, manufacturer Norsk Titanium proudly discusses a BTF Ratio of 3:1 for its plasma arc deposition system/process, in which ⅔ of a manufactured piece was removed by machining to achieve the finished part. This demonstrates unquestionably the efficacy of the system and method according to the present invention for not only providing a novel method to effect omni-directional wire-based 3D printing using plasma arc based techniques according to the exemplary embodiment of the present invention, as it offers significant reduction in waste compared to conventional systems and methods, as well as the ability to deposit the metal at very high rates. It will be understood that the present invention is not limited to a plasma arc system and method, as other high-intensity energy deposition techniques may also be used according to the present invention.

The system and process according to the present invention achieves other important advantages in comparison to conventional plasma arc 3D printing technologies, such as the Norsk technology discussed above. As an example, consider 3D printing a rectangular “picture frame”. Using the conventional technologies, even technology using a six axis robot, it is necessary to print in a straight line the left vertical side of the frame and stop the process. The robot then has to rotate the weld head (or the part must be moved) by 90°, restart the process on top of the existing end of the weld, which is technically difficult, and then move in a straight line until it reaches the top right of the picture frame, whereupon it stops again. The robot repositions the weld head, again by 90°, starts another straight line weld to produce the right hand, vertical side of the picture frame. It has to stop again, reposition by 90° and then move in a straight line back leftwards, to meet up and finish on the bottom of the left vertical side of the frame. In total, the process is started four times and stopped four times for each layer being printed, because you have to print four straight lines. Starts and stops take typically 5 seconds each, so 40 seconds is wasted on each layer of the frame print.

Conversely, using the system and method according to the exemplary embodiment of the present invention, there is no need to start or stop operation of the system to print such a “picture frame”. Rather, a robot incorporating the system can print the first side, move the wires at the first corner either up or down a small amount, which takes milliseconds, and carries on at 90° to the first line. It then repeats these actions until the first layer of the frame is complete. At the end of the first layer, the wires can quickly be repositioned to start the second layer, while the robot increments upwards the height of the first layer the system can keep running. Thus, after printing 100 layers, for example, the system and method according to the embodiment of the present invention would have saved 400 starts and stops, amounting to 4,000 seconds, or 67 minutes. Machines performing plasma printing can earn thousands of dollars per hour, so the benefits are easily seen in this example. Also, achieving perfect starts and stops is technically very difficult, so reducing the number of starts and stops can avoid problems created by imperfect starts and stops.

### Modifications Involving More Than Two Metal Wires

The exemplary embodiment of the present invention discussed above involves the use of two metal wires being fed into different portions of a melt pool formed by a plasma arc, omni-directional wire-based 3D printing. However, the present invention is not limited to the use of two wires.

The inventor conducted further experiments of plasma arc, omni-directional wire-based 3D printing systems using three metal wires and four metal wires, where the wires were equally spaced around a melt pool at 120° intervals for the three wire system and at 90° intervals around the melt pool for the four wire system, in which positioning of the height and location of each of the metal wires were independently controlled similar to the positioning in the two wire system according to the embodiment of the present invention. Using more than two wires can increase the rates of metal deposition and correspondingly, productivity of the systems.

With the system involving three wires, it was discovered that undesirable stirring of the melt pool was prone to happen, which may have been due to variations of the cast in the wires causing imbalances in the metal pool that was formed. Oftentimes, the deposited metal would “migrate” away from the programmed course. Particularly, a deposit formed using the system involving three wires had an irregular shape of a deposited bead 50 which was not distributed uniformly about a point where 3 wires were introduced, and the formed deposit deviated from a center point of where the three wires were introduced into a melt pool.

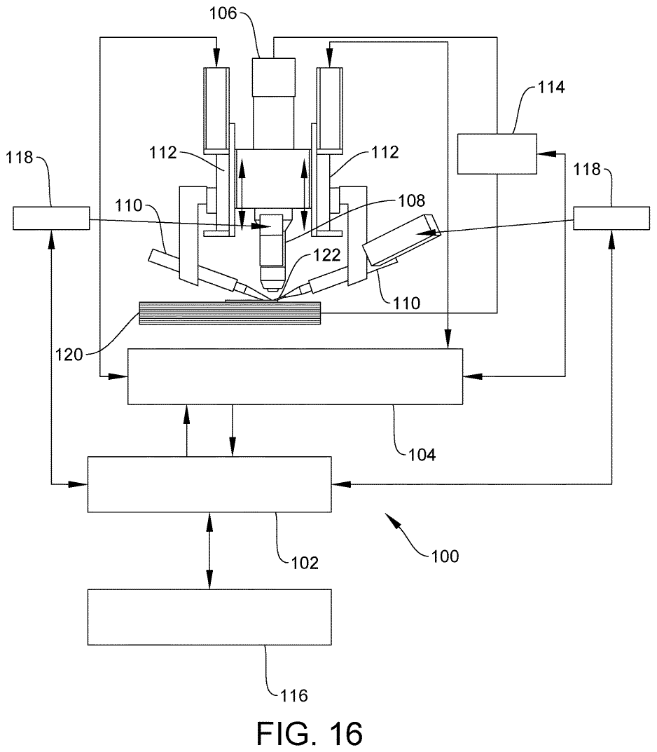

Referring to FIG. 16, there is a side perspective view of a system 60 according to an embodiment of the present invention involving four wires disposed at 90° to one another around the plasma torch head 62. Although this system 62 proved capable of printing high quality 3D parts and deposits similar to the two wire system according to the discussed embodiment of the present invention, it required a significantly increased space to accommodate four independently controlled wire positioning mechanisms 64 for the respective wires, and this undesirably reduces the useable or reachable space within a given size enclosure surrounding the 3D printing system and thus reduced the size of parts that could be printed using a system having the given size enclosure. As understood in the art, when 3D printing of metal parts using special metals such as titanium required by the aerospace industries, the printing must be done under a carefully controlled atmosphere of an inert gas such as argon. However, argon is very expensive and the larger the enclosure surrounding a 3D plasma arc printing system, the more argon required and the longer delays required for purging air out of the enclosure, resulting in much greater cost as the size of the enclosure is increased.

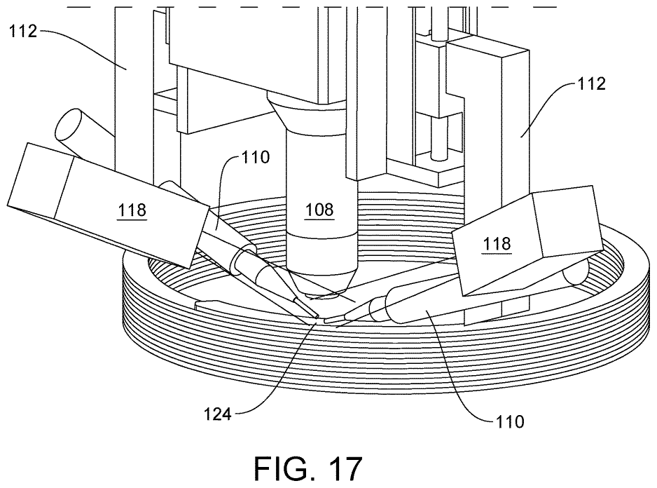

It was determined that a more compact, and hence more suitable, alternative system 70 according to an embodiment of the present invention, may involve the use of four metal wires 75 disposed in an arrangement as shown in FIG. 17, wherein the system 70 independently positions the wires in pairs, with a pair of wire positioning mechanisms 74 for each of the pair of wires 75 being disposed adjacent to each other and connected to a single, servo-driven, slide carriage (not shown) that is CNC controlled so that each pair of the wires 25 is introduced into essentially the same position of a melt pool formed by the plasma torch head 72. With this arrangement two of the wires 75 may be added to the front leading edge of the melt pool and the other two wires 75 may be added to the rear trailing edge of the melt pool. Unlike the situation in the system 60 of FIG. 16 where the four wires are disposed at 90° spacing to one another and requiring each wire to have its own individual height adjustment slide carriage, the system 70 only requires the use of a total of two slide carriages. This is desirable. Not only is the bulk of the system 60 involving the four independently positioned wire positioning mechanisms 64 reduced, but the programming of the CNC wire lifting operations is simplified.

In an example, the system 70 was used to print a circular shaped 3D part using 1.2 mm titanium wires. A range of circular print paths was investigated that varied between 100 and 300 mm, with bead widths ranging from 8 mm to 18 mm. Within these boundaries, the movement path of the plasma torch head 72 was divided into twelve equal segments of 30° each, and at each segment, making adjustments to the heights of the two pairs of wires 75 above a substrate proved extremely effective in permitting omni-directional and very accurate 3D printing of a high quality metal part by creating a 3D metal bead having uniform height and width on a substrate.

### Modifications Involving More Than Five Axes of System Motion

Although the exemplary embodiment of the present invention as discussed above may desirably involve only five (5) axes of motion for the system producing the 3D metal part, the present invention is not limited thereto. For example, while the substrate on which a metal 3D part is formed may be supported on a non-moving surface, the support surface may be movable in at least one of a rotating motion and a tilting motion while the 3D metal part is being formed, while still avoiding undesirable problems of parts entanglement and the like. For example, movements of the support surface may be made in very small increments for generating a part having a curved 3D surface without causing any entanglement problems. Such minute incremental movements of the support surface are quite different from the repetitive back-and-forth movements of the conventional plasma arc welding system which invariably lead to parts entanglements.

As another example, while the exemplary, 5 axis embodiment may move the plasma arc welding torch along three axes (X, Y, Z), the system and method according to the present invention is also usable with a six (6) axis robot. Robots conventionally available today can be so adapted such that the independent servo axes for adjusting the height of wire positioning mechanisms may be integrated as axes of a robot arm. Further, such 6 axis robot may also work in combination with other tilting/rotating devices, which act as additional axes that may be controlled when forming a 3D metal part. For example, it is conventional to use two robots together when forming a part using plasma arc technology, e.g., with one robot that moves the weld-head and the other which moves the substrate, giving twelve (12) axes in total. The present invention is intended to encompass use of such robots.

### Enhancement Involving AI

The exemplary embodiment described herein using a plasma arc as an energy source involves a complex interaction between the plasma torch, the wires to be melted and deposited, and the substrate on which an accurate and highly consistent weld bead must be formed. While an operator may become sufficiently knowledgeable and skilled to successfully implement the technique in a production environment, but even the most skilled and knowledgeable operator has physical and mental limits, e, g., when forming a 3D metal part a using plasma arc 3D printing system, the operator may become physically and mentally exhausted after about 5-6 hours because of the numerous factors that must be considered for properly controlling the system. This becomes a practical problem when the part being produced is extremely large and complex and may take multiple weeks to fully produce, again noting that starting and stopping of the production process is time consuming and may lead to defects.

With this being said, Artificial Intelligence (AI) is rapidly becoming an everyday tool applied to the human-machine relationship throughout the world and is proving important in reducing the human input required for successfully operating machines. After much experimentation the present inventor has developed a process for producing a 3D metal part according the present invention that involves AI to make the system and method according to the present invention not only more efficient in operation, but significantly improves and expands the abilities of the technology such that it can make much larger and complex metal parts that may take weeks to produce, but with much higher and consistent quality than has proven possible using only human operator skill and knowledge.

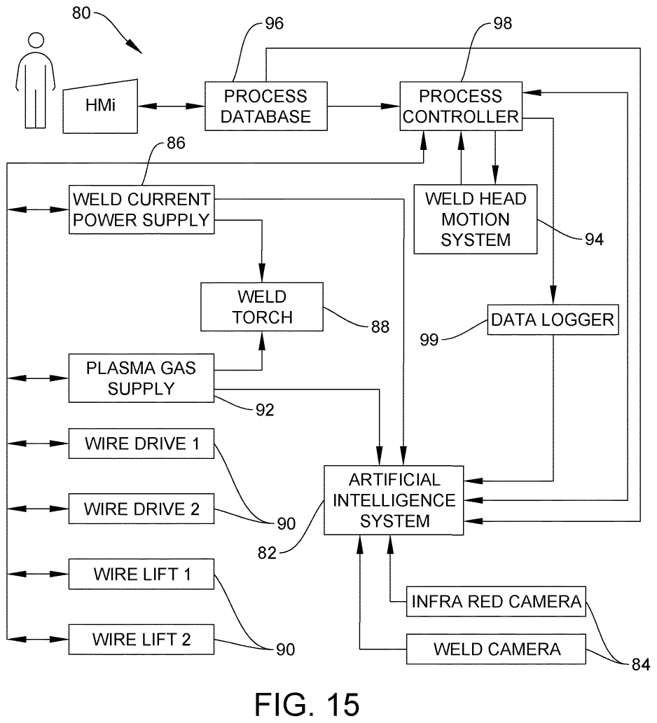

Referring to FIG. 15, there is shown a schematic layout of an embodiment of an AI controlled system 80 for forming a three dimensional (3D) metal part using plasma arc technology including a plasma arc welding torch and wire positioning mechanisms, a process controller, etc., together with an AI control system 82, according to the present invention. The AI control system 82 may not be physically present together with the other components of the system, but may be remotely located or cloud based and otherwise configured to communicate and interact with the other components of the system in real time speed in the formation of 3D metal parts. In this AI controlled system 80, the AI control system 82 may fully or partially replace human operator(s), and allows the system to do many things simultaneously that the human operator(s) are incapable of doing, including obtaining inputs from infrared cameras 84 and other monitoring devices and making real time adjustments to the welding current from a weld current power supply 86 based on the temperature outputs of the infrared cameras 84 and other monitoring devices, as well as moving the plasma welding torch 88 and its torch head 88 in X, Y, Z directions via a weld head motion system 94, controlling movements of wire height adjustment mechanisms 90, controlling output of a plasma gas supply 92 to the plasma welding torch 88, controlling movements of a surface supporting a substrate on which the 3D metal part is being formed, etc. The system 80 may include other components to support control via the AI system 82, including an process database 96, one or more process controllers 98, each of which may be a microprocessors having a memory and operations control software configured to control operations of system components, a datalogger 99, etc. The AI controlled system 80 according to the embodiment of the present invention is a very powerful computing system that can perform literally hundreds of tasks simultaneously to keep the printing process ultra stable at all times and do it almost without time limit, thus allowing massive and complex 3D metal parts to be made over extended manufacturing times.

Referring to FIG. 16 there is shown a schematic layout of an exemplary embodiment of a plasma arc 3D printing system 100 which includes an AI control system 102 together with plasma arc technology according to an exemplary embodiment of the present invention, and referring to FIG. 17 there is shown perspective view of infrared camera monitoring used in such embodiment while generating a circular 3D metal deposit.

The AI controlled system 100 of FIG. 16 separately includes the AI control system 102 another control system 104 used to control a welding arc plasma torch 106 including a weld head 108, wire guiding mechanisms 110, servo driven wire height adjustment mechanisms 112, weld current power supply 114, etc. It will be understood, however, that adoption of more powerful computational devices could enable the implementation of a single computer to command all functions, and similarly remote cloud based AI computational systems could be utilized for the said purpose.

As shown, the AI controlled system 102 may receive data and process it from infrared cameras 118 and other such devices such as a laser based profile scanner 116 that could be mounted in such a way as to determine the characteristic values of a melt pool of molten metal from metal wires 122, a liquidation zone surrounding the metal melt pool, the metal wires including portions thereof that are being melted, the metal material 120 being deposited in beads, the characteristics of the 3D metal part being formed, the plasma arc, the characteristics of the 3D metal part being formed, etc., including topographies and temperature profiles, and, if necessary, enact changes to the parameters that define the process, ensuring the desired or target shape and dimensions of the completed print are met. FIG. 17 is a view of a preferred embodiment for the deployment of the, in this case two, infrared cameras 118 when the system is used to generate a circular 3D metal deposit. The cameras 118 may be Infra-Red, Mono-chromatic, color or a combination of these. It should be obvious that the perspective fields of view 124 of the cameras may differ in different applications of the technology. More than two cameras 118 can be used for monitoring the metal melt pool, metal beads being deposited, etc., but exemplary trials have proven that a front three-quarter view and a side view such as shown work sufficiently well.

In operation of the AI controlled system 100, the actual characteristic values of the a melt pool of molten metal from metal wires 122, a liquidation zone surrounding the metal melt pool, the metal wires including portions thereof that are being melted, the metal material 120 being deposited in beads, the 3D metal part being formed, the plasma arc, etc., as monitored by the infrared camera(s) 118, the laser-based deposit profile scanner and any other monitoring devices are continuously fed to the AI control system 102 and in real time the AI control system 102 may continuously compare these actual characteristic values to target values that have been pre-determined and may be stored in memory of the process database 96 or process controller(s) 98, and to any extent that there are any discrepancies between the actual values and the target values the AI control system 102 will make necessary adjustments to the controls of one or more components of the plasma arc technology, e.g., in a feedback control scheme, so as to cause the actual characteristic values to approach and correspond to the target values. In an actual example of the AI controlled system 100, the adjustments to the controls of one or more components of the plasma arc technology were made in fractions of a second, and the results of the adjustments were also recognizable in fractions of a second, such that the 3D metal part was of very high quality exceeding that which has been possible with human operator control of the plasma arc technology.

Attached hereto is an Appendix-A showing and describing actual examples of AI controlled plasma deposition of metal 3D object according to exemplary embodiments of the present invention

The present invention is not limited in its application to the details of construction and to the dispositions of the components set forth in the foregoing description or illustrated in the appended drawings in association with the present exemplary embodiments of the invention. The present invention is capable of other embodiments and of being practiced and carried out in various ways. In addition, it is to be understood that the phraseology and terminology employed herein are for the purposes of illustration and example, and should not be regarded as limiting. As such, those skilled in the art will appreciate that the concepts, upon which this disclosure is based, may readily be utilized as a basis for the designing of other structures, methods and systems for carrying out the several purposes of the present invention. It is important, therefore, that the claims be regarded as including such equivalent constructions.

For example, it will be recognized that the use of an increased, or decreased in the case of small diameter features, number of segments may be used in printing a circular shaped 3D part in order to maintain or enhance the deposition process. Also, heights of the wires could be continuously varied during motion of the plasma torch head in printing a 3D part of any given shape. This can easily be implemented in a CNC system where servo slides or other mechanisms used to adjust the heights of the wire positioning mechanism are integrated axes of an entire motion system. Most robots on the market today can be so adapted such that the independent servo axes for adjusting the height of wire positioning mechanisms are integrated as axes of a robot arm. The inventor is presently working on the development of such a robot system, as an alternative to the dedicated CNC-type printer such as discussed herein. Given that the system according to the present invention has been described as using a plasma arc welding device for the purpose of 3D printing, a 3D metal printing process according to the present invention could equally well be applied to more conventional “cladding” or “welding” applications.

Although the present invention has been described herein with respect to a specific illustrative embodiment, the foregoing description is intended to illustrate, rather than to limit the invention. Those skilled in the art will realize that many modifications of the preferred embodiment could be made which would be operable. All such modifications are intended to be within the scope and spirit of the present invention.

What is claimed is:

1. A method for forming a three dimensional (3D) metal part using a plasma arc system having a plasma arc welding torch and wire positioning mechanisms which are configured to separately guide metal wires in non-vertical directions, the method comprising steps of:
controlling the wire positioning mechanisms to guide the metal wires to positions within a plasma arc created by the plasma arc welding torch to form a common metal melt pool; and
moving the plasma arc welding torch in X and Y directions within a plane while simultaneously, independently adjusting heights of the metal wires, as guided by the wire positioning mechanisms, relative to the metal melt pool so as to create a 3D metal bead having uniform height and width on a substrate.

2. The method according to claim 1, wherein the plasma arc system further include height adjustment mechanisms for independently adjusting heights of the wire positioning mechanisms to adjust the heights of the metal wires, the height adjustment mechanisms including motors.

3. The method according to claim 1, wherein the plasma arc system includes two of the wire positioning mechanisms which respectively guide two of the metal wires into the plasma arc at opposite side positions relative to a direction of motion of the plasma arc welding torch, and the metal wires as guided into the plasma arc at the opposite side positions are positioned at different entry point heights into the plasma arc based on locations of the opposite side positions relative to the direction of motion of the plasma arc welding torch.

4. The method according to claim 3, wherein when the wire positioning mechanisms guide the metal wires into the plasma arc at locations on opposite front and rear side positions relative to the direction of motion of the plasma arc welding torch, the metal wire guided into the plasma arc at the rear side position is positioned at an entry point height above an entry point height of the metal wire guided into the plasma arc at the front side position.

5. The method according to claim 3, wherein a difference in the entry point heights of the metal wires into the plasma arc becomes greater as the location of a front one of the locations on the front side position is closer to the travel direction of motion of the plasma arc welding torch.

6. The method according to claim 3, wherein when the wire positioning mechanisms guide the metal wires into the plasma arc at locations on opposite lateral side positions displaced 90° relative to the direction of motion of the plasma arc welding torch, the metal wires are positioned a same entry point height into the plasma arc.

7. The method according to claim 1, wherein each of the wire guiding mechanisms guides at least one of the metal wires.

8. The method according to claim 1, wherein the plasma arc system includes two of the wire positioning mechanisms, and wherein the method involves only five axes of movement of the plasma arc system, including the X and Y directional planar movements of the plasma arc welding torch, Z axis movements of the plasma arc welding torch for increasing the height of the welding torch, and independent adjustments of the heights of the two wire positioning devices.

9. The method according to claim 1, wherein speeds at which the wires are fed into the plasma arc are varied while forming the 3D metal part.

10. The method according to claim 1, wherein at least two of the metal wires have different diameters.

11. The method according to claim 1, wherein the plasma arc system further includes a shielding device that delivers a shield of inert gas to a position trailing the plasma arc in a direction of motion of the plasma arc welding torch, the plasma arc welding torch discharges a plasma gas to form the plasma arc, and the method comprises a further step of changing a flow rate of at least one of the plasma gas and the inert gas.

12. The method according to claim 1, wherein the substrate is supported on a surface, and the surface is movable in at least one of a rotating motion and a tilting motion while the 3D metal part is being formed.

13. The method according to claim 1, wherein the plasma arc system further includes an artificial intelligence (AI) control system, and at least one infrared camera which is configured to continuously obtain images of the metal melt pool and the 3D metal bead being generated, which images contain values of characteristic of the metal melt pool and the 3D metal bead being generated, and wherein the method further comprises steps of:
continuously inputting the characteristic values of the metal melt pool and the 3D metal bead being generated from the at least one infrared camera to the AI control system;
causing the AI control system to compare the inputted characteristic values to predetermined target values for the characteristics; and
when there are any discrepancies between the inputted characteristic values and the target characteristic values, causing the AI control system to adjust controls of one or more components of the plasma arc system, so as to cause the inputted characteristic values to approach or correspond to the target characteristic values in real time.

14. The method according to claim 1, wherein the plasma arc system further includes at least one control processor having a memory and control software configured to control operations of the plasma arc system, and the predetermined target values are stored in the memory.

15. A wire-based, plasma arc, three dimensional (3D) printing system, comprising:
a plasma arc welding torch;
wire positioning mechanisms which are configured to separately guide metal wires to positions within a plasma arc created by the plasma arc welding torch for forming a metal melt pool; and
height adjusting mechanisms configured to independently adjust heights of the metal wires as guided by the wire positioning mechanisms relative to the metal melt pool during motions of said plasma arc welding torch so as to create a 3D metal bead having uniform height and width.

16. The wire-based, plasma arc, three dimensional (3D) printing system according to claim 15, wherein the height adjustment mechanisms including motors.

17. The wire-based, plasma arc, three dimensional (3D) printing system according to claim 15, including two of the wire positioning mechanisms which are configured to respectively guide two of the metal wires into the plasma arc at opposite side positions relative to a direction of motion of the plasma arc welding torch, and to position the metal wires as guided into the plasma arc at the opposite side positions at different entry point heights into the plasma arc based on locations of the opposite side positions relative to the direction of motion of the plasma arc welding torch.

18. The wire-based, plasma arc, three dimensional (3D) printing system according to claim 17, wherein when the wire positioning mechanisms are configured to guide the metal wires into the plasma arc at locations on opposite front and rear side positions relative to the direction of motion of the plasma arc welding torch, and to position the metal wire guided into the plasma arc at the rear side position at an entry point height above an entry point height of the metal wire guided into the plasma arc at the front side position.

19. The wire-based, plasma arc, three dimensional (3D) printing system according to claim 17, wherein the wire positioning mechanisms are configured to guide the metal wires into the plasma arc at the locations on opposite front and rear side positions relative to the direction of motion of the plasma arc welding torch such that a difference in the entry point heights of the metal wires into the plasma arc becomes greater as the location of a front one of the locations on the front side position is closer to the travel direction of motion of the plasma arc welding torch.

20. The wire-based, plasma arc, three dimensional (3D) printing system according to claim 15, wherein the plasma arc system includes two of the wire positioning mechanisms, and wherein the wire-based, plasma arc, three 3D printing system is configured to print a 3D metal part using only five axes of movement thereof, including the X and Y directional planar movements of the plasma arc welding torch, Z axis movements of the plasma arc welding torch for increasing the height of the welding torch, and independent adjustments of the heights of the two wire positioning devices.
